(19) United States
(12) Patent Application Publication
(10) Pub. No.: US 2014/0298168 A1
(43) Pub. Date: Oct. 2, 2014

(54) SYSTEM AND METHOD FOR SPELLING CORRECTION OF MISSPELLED KEYWORD

(71) Applicant: EST soft Corp., Seoul (KR)

(72) Inventor: Kun-Young SON, Seoul (KR)

(73) Assignee: EST soft Corp., Seoul (KR)

(21) Appl. No.: 14/225,415

(22) Filed: Mar. 25, 2014

(30) Foreign Application Priority Data
Mar. 28, 2013 (KR) 10-2013-0033866

(51) Int. Cl. G06F 17/27; G06F 17/24

(52) U.S. Cl. CPC G06F 17/273; G06F 17/24
USPC 715/257

(57) ABSTRACT

A spelling correction system and method are provided. The system includes at least an input unit, a correct keyword candidate determining unit, and a misspelling correction unit. In the method, the input unit detects an input keyword entered by a user. If the input keyword is a misspelled keyword, the correct keyword candidate determining unit selects one or more correct keyword candidates for the input keyword and then returns the selected correct keyword candidates. The misspelling correction unit obtains a misspelling appearance probability of a pair of the input keyword and each correct keyword candidate, and also obtains a word appearance probability of each correct keyword candidate. Then the misspelling correction unit selects a specific correct keyword from among the correct keyword candidates by using the misspelling appearance probability and the word appearance probability.

### TECHNICAL FIELD

The present invention relates to a system and method for correcting a misspelled search query.

### BACKGROUND

Spelling correction technology has been developed to find a wrong search keyword entered by a user and, based on probabilities, to suggest a proper keyword estimated to be desired by the user. Normally misspelling may be classified into two types. One type is a typographical error caused by a wrong typing of a keyword on a keyboard, and the other type is a cognitive error caused by a misunderstanding about spelling of a keyword.

Typical spelling correction technology is based on a dictionary. According to this technology, a word which is not found in a dictionary is regarded as a misspelled keyword, and a specific candidate for a correct keyword is selected among similar words in a dictionary.

However, spelling correction of a search query, depending on any existing dictionary only, may often fail to obtain exact and reliable results. Considering that a search query may assume a great variety of forms and occasionally contain a newly-coined internet word or the like, it is not easy to actually construct a database that contains all probable words.

Accordingly, there is a need to accumulate log data on users' search queries and try to find a new method for performing spelling correction of a search query on the basis of the accumulated log data.

### SUMMARY

In order to address the above-mentioned problems and/or disadvantages and to offer at least the advantages described below, the present invention provides a spelling correction method that includes extracting at least one group of correct keyword candidates when a certain search keyword entered by a user is determined to be a misspelled word, selecting a specific keyword having the highest probability of a user's desired keyword from among the extracted candidates, and replacing the entered search keyword with the selected keyword or offering the selected keyword as a recommended word.

According to one aspect of the present invention, provided is a spelling correction system that comprises an input unit configured to detect an input keyword entered by a user; a correct keyword candidate determining unit configured to select one or more correct keyword candidates for the input keyword if the input keyword is a misspelled keyword, and to return the selected correct keyword candidates; and a misspelling correction unit configured to obtain a misspelling appearance probability of a pair of the input keyword and each correct keyword candidate, to obtain a word appearance probability of each correct keyword candidate, and to select a specific correct keyword from among the correct keyword candidates by using the misspelling appearance probability and the word appearance probability.

In the system, if the input keyword is found in a list of cached keywords having the word appearance probabilities higher than a given threshold, the misspelling correction unit may be further configured to select, as the correct keyword, a specific keyword matched to the input keyword.

In the system, the misspelling correction unit may be further configured to select, as the correct keyword, the correct keyword candidate having the greatest value of product of the misspelling appearance probability and the word appearance probability.

The system may further comprise a misspelling appearance probability computing unit configured to extract error data from a search query log containing the input keywords, and to create an error model database by calculating the misspelling appearance probability of the extracted error data.

The system may further comprise a word appearance probability computing unit configured to extract word appearance data from a search query log containing the input keywords, and to create a language model database by calculating the word appearance probability of the extracted word appearance data.

In the system, the correct keyword candidate determining unit may be further configured to determine, as the correct keyword candidate, a specific word having the same phonetic index as a pronunciation of the input keyword.

In the system, the correct keyword candidate determining unit may be further configured to divide the input keyword into alphabetic letters, to create bi-gram based on a two-letter combination of the divided letters or tri-gram based on a three-letter combination of the divided letters, to compare the created bi-gram or tri-gram with n-gram index containing pairs of a word and a corresponding bi-gram or tri-gram, and to determine, as the correct keyword candidate, a specific word corresponding to a matched bi-gram or tri-gram.

In the system, the correct keyword candidate determining unit may be further configured to retrieve at least one word containing the bi-gram or tri-gram of the input keyword from the n-gram index, to calculate similarity between the input keyword and each retrieved word, and to determine, as the correct keyword candidate, at least one of the retrieved words in a descending order of the similarity.

In the system, the correct keyword candidate determining unit may be further configured to compare the input keyword with words stored in a language model database, and to determine, as the correct keyword candidate, at least one of the stored words in an ascending order of an edit distance from the input keyword, and wherein the edit distance is the sum of weighted values predefined for each of substitution, addition, deletion and change and also obtained depending on frequency of substitution, addition, deletion or change between alphabetic arrangements of the input keyword and the stored words.

According to another aspect of the present invention, provided is a spelling correction method that comprises detecting an input keyword entered by a user; determining one or more correct keyword candidates for the input keyword if the input keyword is a misspelled keyword; obtaining a misspelling appearance probability of a pair of the input keyword and each correct keyword candidate and also obtaining a word appearance probability of each correct keyword candidate; selecting a specific correct keyword from among the correct keyword candidates by using the misspelling appearance probability and the word appearance probability; and returning the selected correct keyword.

The method may further comprise, after the detecting of the input keyword, if the input keyword is found in a list of cached keywords having the word appearance probabilities higher than a given threshold, selecting, as the correct keyword, a specific keyword matched to the input keyword.

In the method, the selecting of the correct keyword may includes selecting, as the correct keyword, the correct keyword candidate having the greatest value of product of the misspelling appearance probability and the word appearance probability.

The method may further comprise, before the detecting of the input keyword, extracting error data from a search query log containing the input keywords, and creating an error model database by calculating the misspelling appearance probability of the extracted error data.

The method may further comprise, before the detecting of the input keyword, extracting word appearance data from a search query log containing the input keywords, and creating a language model database by calculating the word appearance probability of the extracted word appearance data.

In the method, the determining of the correct keyword candidate may include determining, as the correct keyword candidate, a specific word having the same phonetic index as a pronunciation of the input keyword.

In the method, the determining of the correct keyword candidate may include dividing the input keyword into alphabetic letters and then creating bi-gram based on a two-letter combination of the divided letters or tri-gram based on a three-letter combination of the divided letters; comparing the created bi-gram or tri-gram with n-gram index containing pairs of a word and a corresponding bi-gram or tri-gram; and determining, as the correct keyword candidate, a specific word corresponding to a matched bi-gram or tri-gram.

In the method, the determining of the correct keyword candidate may further include retrieving at least one word containing the bi-gram or tri-gram of the input keyword from the n-gram index; calculating similarity between the input keyword and each retrieved word; and determining, as the correct keyword candidate, at least one of the retrieved words in a descending order of the similarity.

In the method, the determining of the correct keyword candidate may include comparing the input keyword with words stored in a language model database; and determining, as the correct keyword candidate, at least one of the stored words in an ascending order of an edit distance from the input keyword, and further the edit distance may be the sum of weighted values predefined for each of substitution, addition, deletion and change and also obtained depending on frequency of substitution, addition, deletion or change between alphabetic arrangements of the input keyword and the stored words.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating the configuration of a spelling correction system in accordance with an embodiment of the present invention.

FIG. 2 is a flow diagram illustrating a method for creating an error model database and a language model database by using a users' search query log in a spelling correction system in accordance with an embodiment of the present invention.

FIGS. 3A and 3B show a process of creating a language model database based on a users' search query log and calculating a word appearance probability in a spelling correction system in accordance with an embodiment of the present invention.

FIGS. 4A to 4F show a process of creating an error model database based on a users' search query log and calculating a misspelled letter appearance probability in a spelling correction system in accordance with an embodiment of the present invention.

FIG. 5 is a flow diagram illustrating a method for performing spelling correction of a search keyword entered by a user in a spelling correction system in accordance with an embodiment of the present invention.

FIGS. 6A to 6D show a process of determining correct keyword candidates in response to a misspelled keyword in a spelling correction system in accordance with an embodiment of the present invention.

### DETAILED DESCRIPTION

The following description with reference to the accompanying drawings is provided to assist in a comprehensive understanding of various embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a query” includes reference to one or more of such queries.

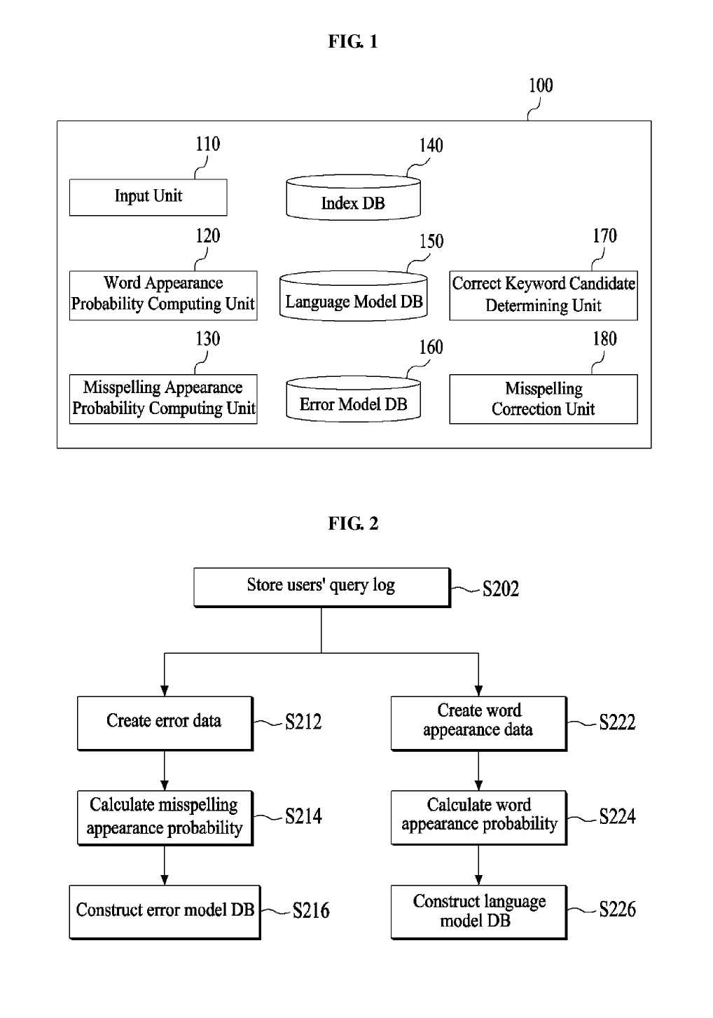

FIG. 1 is a block diagram illustrating the configuration of a spelling correction system in accordance with an embodiment of the present invention.

As shown in FIG. 1, the spelling correction system 100 may include an input unit 110, a word appearance probability computing unit 120, a misspelling appearance probability computing unit 130, an index DB 140, a language model DB 150, an error model DB 160, a correct keyword candidate determining unit 170, and a misspelling correction unit 180.

The input unit 110 detects a search keyword entered by a user and returns corresponding input keyword data. Hereinafter, this input keyword data returned by the input unit 110 will be shortly referred to as an input keyword.

Input keywords used in a search process are stored in a search query log and used as basic data for constructing both the language model DB 150 and the error model DB 160. A method for creating both the language model DB 150 and the error model DB 160 is shown in FIG. 2.

The word appearance probability computing unit 120 extracts word appearance data from the search query log and creates the language model DB 150 by calculating a word appearance probability of the extracted word appearance data.

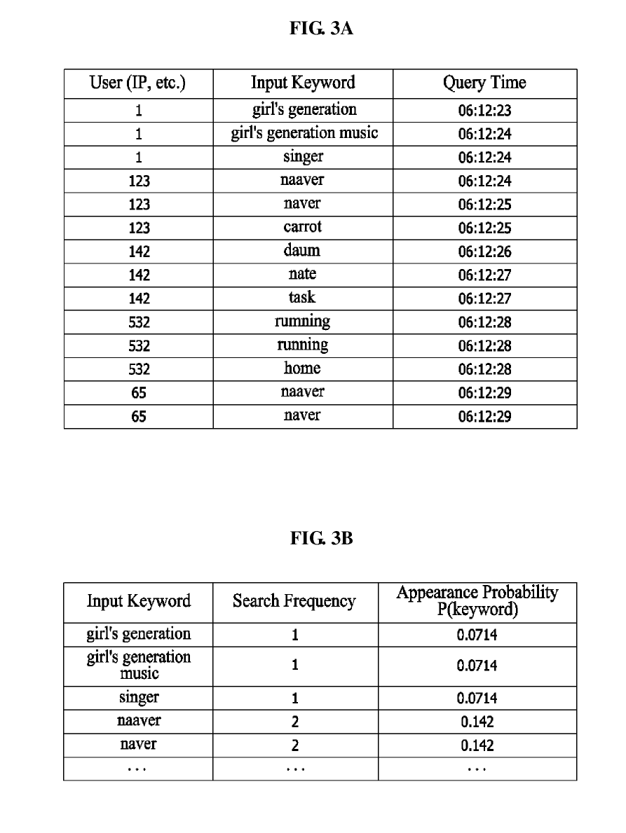

FIGS. 3A and 3B show an example of the language model DB 150 that contains therein the extracted word appearance data and word appearance probabilities thereof.

Let's suppose, for example, that FIG. 3A shows an search query log which is accumulated for a certain period of time with regard to unspecified users. In this log, the total number of query appearance is fourteen. For example, a certain keyword “girl's generation” appears once, and another keyword “naaver” appears twice.

The word appearance probability computing unit 120 counts the appearance frequency (i.e., search frequency) for each input keyword, then creates word appearance data (step S222 in FIG. 2), and calculates the word appearance probability of each input keyword (step S224 in FIG. 2). Here, the word appearance probability P( ) may be calculated using Equation 1 given below.

P(keyword)=(keyword search frequency)/(sum of search frequencies of total input keywords) [Equation 1]

Using the search query log shown in FIG. 3A, the word appearance probability of a keyword “girl's generation”, P (girl's generation), is 0.0714 (=1/14), and the word appearance probability of a keyword “naaver”, P(naaver), is 0.142 (=2/14).

In case there are two or more candidates for a correct keyword regarding a certain misspelled keyword, the word appearance probability of each input keyword may be used for giving an extra point to a specific candidate having a higher word appearance probability.

The word appearance data is stored in the language model DB 150 as shown in FIG. 3B (step S226 in FIG. 2). Here, the word appearance data may include data about a log count period which is used as a factor of the word appearance probability.

Returning to FIG. 1, the misspelling appearance probability computing unit 130 extracts error data from the search query log and creates the error model DB 160 by calculating a misspelling appearance probability of the extracted error data.

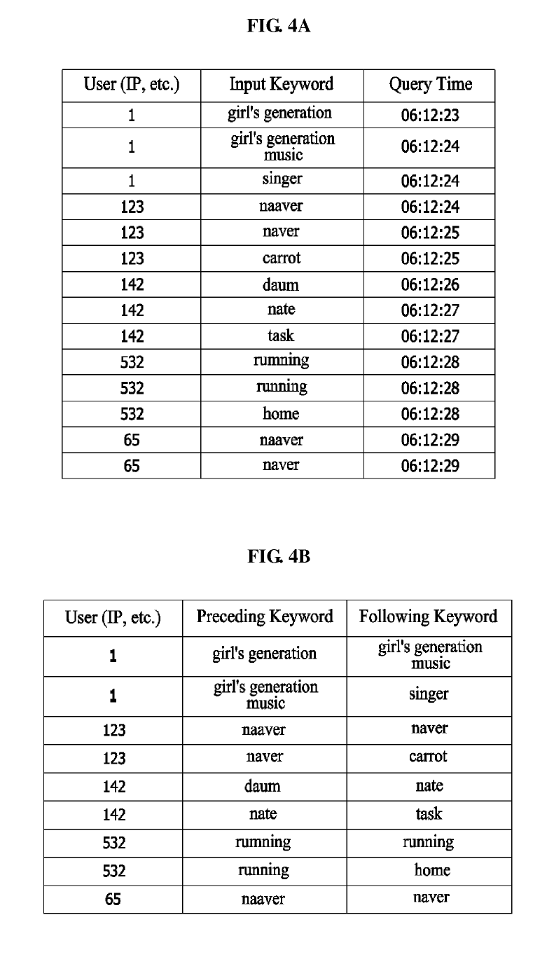

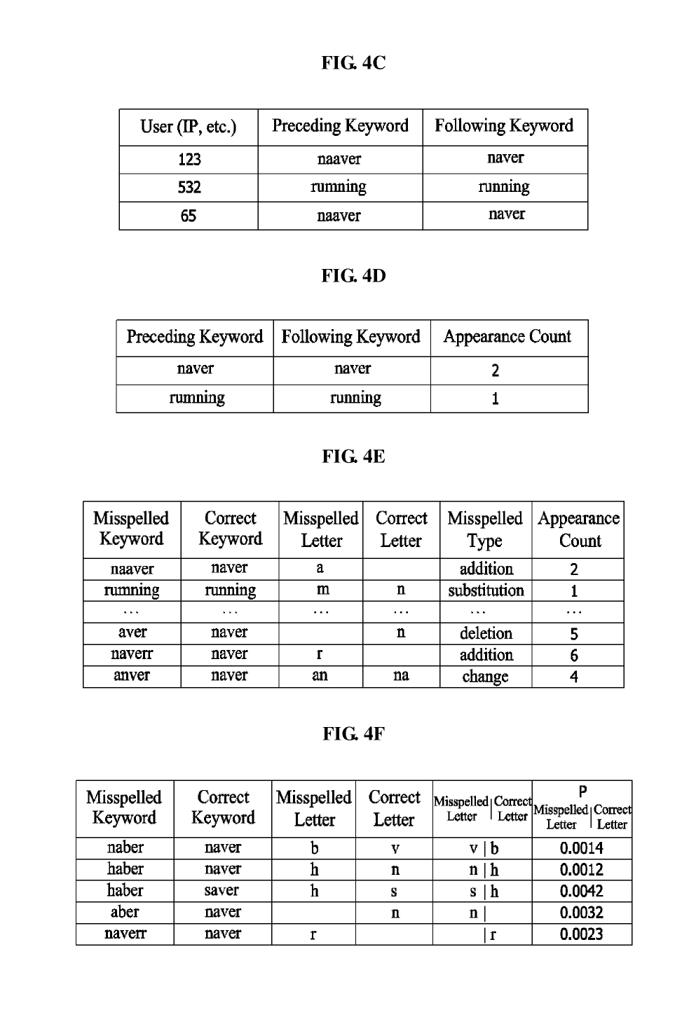

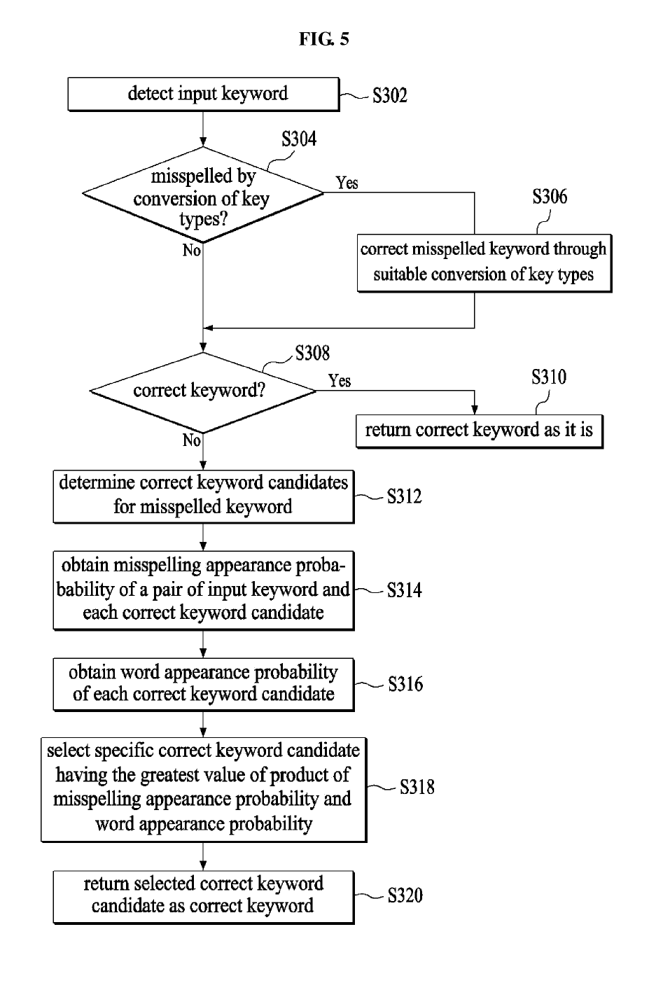

FIGS. 4A to 4F show an example of the error model DB 160 that contains therein the extracted error data and misspelled letter appearance probabilities thereof (hereinafter, referred to as misspelling appearance probabilities).

Let's suppose, for example, that FIG. 4A shows an search query log which is created from input keywords entered by unspecified users for a certain period of time. Then the misspelling appearance probability computing unit 130 extracts input keywords entered by the same user for a predefined short period of time, e.g., two or three seconds. As shown in FIG. 4B, extracted results may be composed of preceding keywords and following keywords. Next, the misspelling appearance probability computing unit 130 extracts a record in which the preceding keyword and the following keyword are similar to each other. For example, as shown in FIG. 3C, a preceding keyword “naaver” and a following keyword “naver” may be considered as similar keywords according to predefined criteria. Similarly, a preceding keyword “rumning” and a following keyword “running” may be considered as similar keywords.

When any record having a pair of similar keywords is extracted, the misspelling appearance probability computing unit 130 counts the number of records each having a similar keyword pair, regardless of user who enters a query. Count results are shown in FIG. 4D. This extracted data group is referred to as error data (step S212 in FIG. 2).

Thereafter, the misspelling appearance probability computing unit 130 calculates the misspelling appearance probability of each error data (step S214 in FIG. 2). Here, the misspelling appearance probability P(correct letter|misspelled letter) may be calculated using Equation 2 given below.

P(correct letter|misspelled letter)=(sum of frequencies of a relevant misspelled type)/(sum of frequencies of a total misspelled type) [Equation 2]

Here, a misspelled type includes substitution, addition, deletion, and change. For example, in case a misspelled type is substitution, Equation 2 is as follows: P(correct letter|misspelled letter)=(sum of frequencies of relevant substitution)/(sum of frequencies of total substitution). Similarly, in case a misspelled type is addition, Equation 2 is as follows: P(correct letter|misspelled letter)=(sum of frequencies of relevant addition)/(sum of frequencies of total addition).

An example of four misspelled types is shown in FIG. 4E. A case of misspelling “running” as “rumning” corresponds to a substitution type in which a correct letter “n” is substituted with a misspelled letter “m”. A case of misspelling “naver” as “naaver” corresponds to an addition type in which a misspelled letter “a” is added. A case of misspelling “naver” as “aver” corresponds to a deletion type in which a certain letter “a” is not entered. A case of misspelling “naver” as “anver” corresponds to a change type in which some letters are entered in a wrong order.

As discussed above, the misspelling appearance probability computing unit 130 calculates the misspelling appearance probability P(correct letter|misspelled letter) of each pair of a correct letter and a misspelled letter and then stores the calculated probability in the error model DB 160 (step S216 in FIG. 2). An example of the error model DB 160 is shown in FIG. 4F.

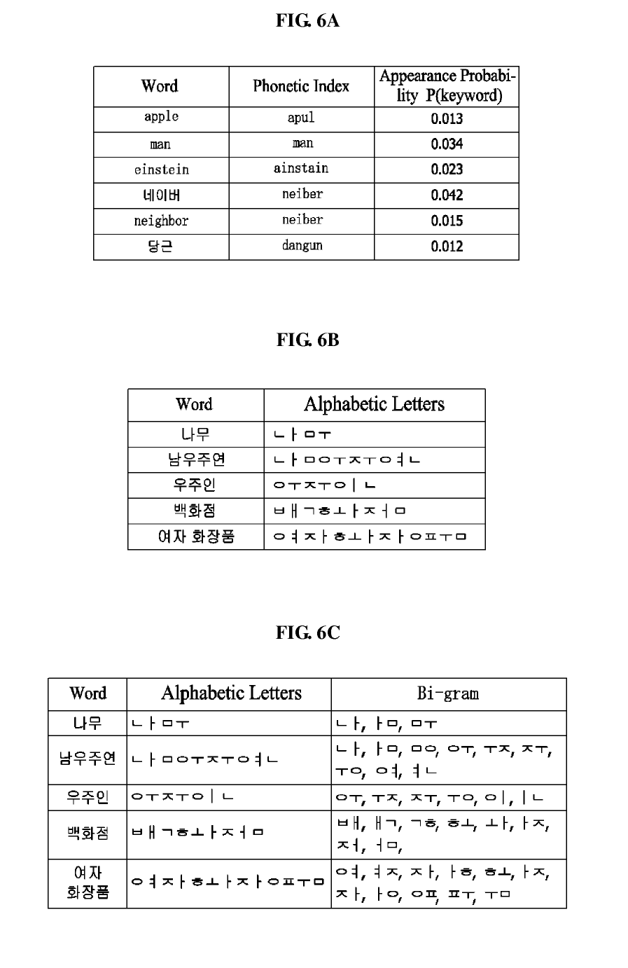

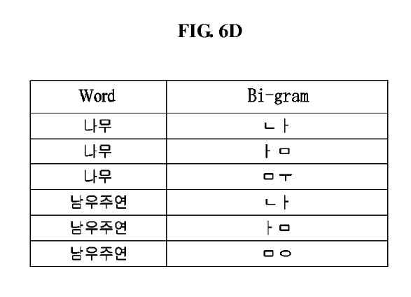

If any input keyword is a misspelled word, the correct keyword candidate determining unit 170 selects at least one group of correct keyword candidates estimated to be similar to the input keyword and then returns the selected candidate group. At this time, the correct keyword candidate determining unit 170 may use the index DB 140 in order to determine such correct keyword candidates. An example of the index DB 140 is shown in FIG. 6.

To select a correct keyword candidate, the correct keyword candidate determining unit 170 may use a suitable combination of the following techniques.

The first technique is based on phonetics. This technique may be used in case a user knows correct pronunciation of a desired search keyword but fails to know an exact spelling. For example, a user's desired keyword is “Einstein”, but an input keyword is misspelled phonetically as “ainstain”.

In this case, the correct keyword candidate determining unit 170 searches the index DB 140 for the input keyword “ainstain” and thereby obtains a word having the same phonetic index. As seen from FIG. 6A, a word having the same phonetic index as the input keyword “ainstain” is “Einstein”, and the appearance probability P(Einstein) is 0.023. If there are two or more candidates, a selected word having a relatively higher appearance probability may be returned by means of a relevant Unicode block in consideration of a language type (i.e., Korean, English, Japanese, etc.) of the input keyword.

A phonetic index may be created by an index creating unit (not shown) which has the ability to create a phonetic index by using a well-known phonetic algorithm such as a Soundex or Metaphone algorithm and store the created index in the index DB 140.

The second technique is based on n-gram index. This technique may be used in case a user's input keyword is matched mostly to a correct word but has partly a misspelled word.

The correct keyword candidate determining unit 170 divides an input keyword into alphabetic letters and then creates bi-gram or tri-gram by combining two letters or three letters in order. For example, in case the input keyword is “ [symbol] ” in Korean (which means a tree and is pronounced as namu), the input keyword “ [symbol] ” is divided into four letters “ [symbol] ”, “ [symbol] ”, “ [symbol] ” and “ [symbol] ” in Korean as shown in FIG. 6B. Then combining two letters in order, three bi-grams “ [symbol] ”, “ [symbol] ” and “ [symbol] ” are created as shown in FIG. 6C.

Meanwhile, the correct keyword candidate determining unit 170 may determine whether to create bi-gram or tri-gram, depending on the length of input keyword. For example, bi-gram may be used in case the input keyword has the number of letters (in any alternative case, phonemes or syllables) smaller than a predefined threshold, and tri-gram may be used in the opposite case.

Thereafter, the correct keyword candidate determining unit 170 retrieves at least one matching word by comparing bi-gram or tri-gram of the input keyword with n-gram index in the index DB 140. Referring to FIG. 6D, when a user enters “ [symbol] ”, the correct keyword candidate determining unit 170 creates three bi-gram queries “ [symbol] ”, “ [symbol] ”, “ [symbol] ”. The result of such queries is as follows.

“ [symbol] ”=“ [symbol] ”

“ [symbol] ”=“ [symbol] ” (which means best actor and is pronounced as namujuyon)

“ [symbol] ”=“ [symbol] ”

“ [symbol] ”=“ [symbol] ”

“ [symbol] ”=“ [symbol] ”

Regarding three bi-gram queries given above, one retrieved keyword “ [symbol] ” is matched three times, and another retrieved keyword “ [symbol] ” is matched twice. In this case, the retrieved keyword “ [symbol] ” has three bi-grams “ [symbol] ”, “ [symbol] ” and “ [symbol] ”, and the retrieved keyword “ [symbol] ” has nine bi-grams “ [symbol] ”, “ [symbol] ”, “ [symbol] ”, “ [symbol] ”, “ [symbol] ”, “ [symbol] ”, “ [symbol] ”, “ [symbol] ” and “ [symbol] ”.

The correct keyword candidate determining unit 170 calculates the similarity r( ) between the input keyword and each retrieved keyword, using Equation 3 given below.

r(input keyword, retrieved keyword)=|S(input keyword)∩S(retrieved keyword)|/|S(input keyword)∪S(retrieved keyword)| [Equation 3]

Here, S( ) denotes a set of bi-grams contained in a keyword.

The similarity r( [symbol] , [symbol] ) between the input keyword “ [symbol] ” and the retrieved keyword “ [symbol] ” is calculated as 1 (=3/3), and the similarity r( [symbol] , [symbol] ) between the input keyword “ [symbol] ” and the retrieved keyword “ [symbol] ” is calculated as 0.2 (=2/10). Therefore, in case a user enters “ [symbol] ”, the retrieved keyword “ [symbol] ” is more similar to the input keyword “ [symbol] ” than the retrieved keyword “ [symbol] ”.

As another example, a user may enter “ [symbol] ” instead of a desired keyword “ [symbol] ”. In this case, the input keyword “ [symbol] ” has four bi-grams “ [symbol] ”, “ [symbol] ”, “ [symbol] ” and “ [symbol] [symbol] ”, and thus four bi-gram queries are issued. The correct keyword candidate determining unit 170 returns retrieved keywords “ [symbol] ” and “ [symbol] ” through comparison with a bi-gram index shown in FIG. 6D. Since the similarities of the above retrieved keyword are 3/4 and 2/11, respectively, the retrieved keyword “ [symbol] ” may be returned as a correct keyword candidate in response to a misspelled input keyword “ [symbol] ”. In some cases, two or more correct keyword candidates may be returned.

Meanwhile, in order to reduce the number of indexes for retrieval, both the foremost token and the backmost token may be identified from the others at the creation of n-gram index. For example, a single underline may be added as prefix to the foremost token and as suffix to the backmost token, as shown in “ [symbol] ”, “ [symbol] ” and “ [symbol] ” in case of “ [symbol] ”. By doing so, the foremost token “ [symbol] ” and the backmost token “ [symbol] ” are not retrieved in case any input keyword contains “ [symbol] ” in the middle thereof rather than at the beginning or end thereof.

The above-discussed technique based on n-gram index may be commonly applied to any other language type. For example, in case a certain input keyword is “tree” in English, this is divided into four alphabetic letters “t”, “r”, “e” and “e”, and then three bi-grams “tr”, “re” and “cc” are created through a two-letter combination. Similarly, in case of “trecorde”, seven bi-grams “tr”, “re”, “ec”, “co”, “or”, “rd” and “de” are created. If a user enters “tree”, the correct keyword candidate determining unit 170 creates three bi-gram queries “tr”, “re” and “ee”. Regarding these queries, one retrieved keyword “tree” is matched three times, and another retrieved keyword “trecorde” is matched twice. Then the correct keyword candidate determining unit 170 calculates the similarity r( ) between the input keyword and each retrieved keyword, using Equation 3. In the above case, the similarity r(tree, tree) between the input keyword “tree” and the retrieved keyword “tree” is calculated as 1 (=3/3), and the similarity r(tree, trecorde) between the input keyword “tree” and the retrieved keyword “trecorde” is calculated as 0.25 (=2/8). Therefore, in case a user enters “tree”, the retrieved keyword “tree” is more similar to the input keyword “tree” than the retrieved keyword “trecorde”. Further, by using the above-discussed token at the creation of n-gram index, the number of indexes for retrieval can be remarkably reduced.

The third technique uses an edit distance. Here, the edit distance refers to the sum of weighted values predefined for each of substitution, addition, deletion and change and also obtained depending on the frequency of substitution, addition, deletion or change between an alphabetic arrangement of an input keyword and that of a target keyword.

By comparing the input keyword with target keywords in the language model DB 150, the correct keyword candidate determining unit 170 determines one or more correct keyword candidates in an ascending order of the edit distance from the input keyword.

For example, in case of the input keyword “potat” having an alphabetic arrangement “p, o, t, a, t” and the target keyword “potato” having an alphabetic arrangement “p, o, t, a, t, o”, a predefined weighted value corresponding to addition is obtained since the addition of “o” occurs. Interrelationship between keywords depends on this edit distance.

The misspelling correction unit 180 obtains the misspelling appearance probability of a pair of the input keyword and each of one or more correct keyword candidates determined and returned by the correct keyword candidate determining unit 170. Then, using the misspelling appearance probability and the word appearance probability of each correct keyword candidate, the misspelling correction unit 180 selects a specific correct keyword from among the correct keyword candidates.

Specifically, the misspelling correction unit 180 may select, as a correct keyword, a correct keyword candidate having the greatest value of the product of the word appearance probability and the misspelling appearance probability, as shown in Equation 4 given below.

Transformed score=MAX(with regard to correct keyword candidates from 1 to n, P(correct keyword candidate)*P(correct letter|misspelled letter)) [Equation 4]

For example, in FIG. 4F, a misspelled keyword “haver” may correspond to a correct keyword candidate “naver” or “saver”. Since P(n|h) is 0.0012 and P(s|h) is 0.042, the correction from “h” to “s” has a higher probability than the correction from “h” to “n”. However, if the word appearance probabilities of “naver”, “saver” and “haver” are 0.08, 0.0002 and 0.000001, respectively, the transformed scores of “naver”, “saver” and “haver” become 0.000096 (i.e., the product of 0.0012 and 0.08), 0.0000084 (i.e., the product of 0.042 and 0.0002), and 0.000001 (i.e., the product of 0.000001 and 1), respectively. Therefore, in case an input keyword is “haver”, the misspelling correction unit 180 determines “naver” as a correct keyword.

Meanwhile, since the logic of the spelling correction system is about words estimated as misspelled words rather than correct words, it is desirable that the above-discussed spelling correction process may be skipped with regard to nearly sure correct words. For this, the misspelling correction unit 180 may cache in advance a specific number of keywords having higher appearance probabilities than a given threshold and compare an input keyword with the cached keywords. If the input keyword is found in a list of the cached keywords, the misspelling correction unit 180 may extract and return a correct keyword matched to the input keyword.

FIG. 5 is a flow diagram illustrating a spelling correction method in accordance with an embodiment of the present invention.

As shown in FIG. 5, when a user inputs a query keyword (step S302), the misspelling correction unit 180 determines whether the input keyword is misspelled due to undesired conversion of key types (e.g., Korean-English conversion, Korean-Japanese conversion, Japanese-English conversion, etc.) (step S304). If so, the misspelling correction unit 180 corrects the misspelled keyword according to suitable conversion of key types (step S306).

Meanwhile, the misspelling correction unit 180 stores some keywords having higher appearance probabilities in a cache memory. If any input keyword is entered, the misspelling correction unit 180 further determines whether the input keyword is a correct keyword (step S308). Namely, at step S308, the misspelling correction unit 180 compares the input keyword with the cached keywords. If the input keyword is matched to any cached keyword, the misspelling correction unit 180 extracts and returns the matched keyword as a correct keyword (step S310).

If the input keyword is not a correct keyword (i.e., a misspelled keyword), the correct keyword candidate determining unit 170 determines correct keyword candidates for the misspelled keyword through the above-discussed process and returns the determined candidates (step S312).

Then the misspelling correction unit 180 obtains the misspelling appearance probability of a pair of the input keyword and each correct keyword candidate (step S314), and also obtains the word appearance probability of each correct keyword candidate (step S316). Thereafter, the misspelling correction unit 180 selects a specific correct keyword candidate having the greatest value of the product of the misspelling appearance probability and the word appearance probability (step S318). The selected correct keyword candidate is returned as a correct keyword (step 320). Namely, the selected correct keyword candidate may be offered as a recommended keyword or used to replace the input keyword with it.

As fully discussed hereinbefore, using accumulated log data on users' search queries, the spelling correction system of this invention can perform a spelling correction process with great accuracy for a search query.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A spelling correction system comprising:
an input unit configured to detect an input keyword entered by a user;
a correct keyword candidate determining unit configured to select one or more correct keyword candidates for the input keyword if the input keyword is a misspelled keyword, and to return the selected correct keyword candidates; and
a misspelling correction unit configured to obtain a misspelling appearance probability of a pair of the input keyword and each correct keyword candidate, to obtain a word appearance probability of each correct keyword candidate, and to select a specific correct keyword from among the correct keyword candidates by using the misspelling appearance probability and the word appearance probability.

2. The system of claim 1, wherein if the input keyword is found in a list of cached keywords having the word appearance probabilities higher than a given threshold, the misspelling correction unit is further configured to select, as the correct keyword, a specific keyword matched to the input keyword.

3. The system of claim 1, wherein the misspelling correction unit is further configured to select, as the correct keyword, the correct keyword candidate having the greatest value of product of the misspelling appearance probability and the word appearance probability.

4. The system of claim 1, further comprising:
a misspelling appearance probability computing unit configured to extract error data from a search query log containing the input keywords, and to create an error model database by calculating the misspelling appearance probability of the extracted error data.

5. The system of claim 1, further comprising:
a word appearance probability computing unit configured to extract word appearance data from a search query log containing the input keywords, and to create a language model database by calculating the word appearance probability of the extracted word appearance data.

6. The system of claim 1, wherein the correct keyword candidate determining unit is further configured to determine, as the correct keyword candidate, a specific word having the same phonetic index as a pronunciation of the input keyword.

7. The system of claim 1, wherein the correct keyword candidate determining unit is further configured to divide the input keyword into alphabetic letters, to create bi-gram based on a two-letter combination of the divided letters or tri-gram based on a three-letter combination of the divided letters, to compare the created bi-gram or tri-gram with n-gram index containing pairs of a word and a corresponding bi-gram or tri-gram, and to determine, as the correct keyword candidate, a specific word corresponding to a matched bi-gram or tri-gram.

8. The system of claim 7, wherein the correct keyword candidate determining unit is further configured to retrieve at least one word containing the bi-gram or tri-gram of the input keyword from the n-gram index, to calculate similarity between the input keyword and each retrieved word, and to determine, as the correct keyword candidate, at least one of the retrieved words in a descending order of the similarity.

9. The system of claim 1, wherein the correct keyword candidate determining unit is further configured to compare the input keyword with words stored in a language model database, and to determine, as the correct keyword candidate, at least one of the stored words in an ascending order of an edit distance from the input keyword, and wherein the edit distance is the sum of weighted values predefined for each of substitution, addition, deletion and change and also obtained depending on frequency of substitution, addition, deletion or change between alphabetic arrangements of the input keyword and the stored words.

10. A spelling correction method comprising:
detecting an input keyword entered by a user;
determining one or more correct keyword candidates for the input keyword if the input keyword is a misspelled keyword;
obtaining a misspelling appearance probability of a pair of the input keyword and each correct keyword candidate and also obtaining a word appearance probability of each correct keyword candidate;
selecting a specific correct keyword from among the correct keyword candidates by using the misspelling appearance probability and the word appearance probability; and
returning the selected correct keyword.

11. The method of claim 10, further comprising:
after the detecting of the input keyword,
if the input keyword is found in a list of cached keywords having the word appearance probabilities higher than a given threshold, selecting, as the correct keyword, a specific keyword matched to the input keyword.

12. The method of claim 10, wherein the selecting of the correct keyword includes:
selecting, as the correct keyword, the correct keyword candidate having the greatest value of product of the misspelling appearance probability and the word appearance probability.

13. The method of claim 10, further comprising:
before the detecting of the input keyword,
extracting error data from a search query log containing the input keywords, and creating an error model database by calculating the misspelling appearance probability of the extracted error data.

14. The method of claim 10, further comprising:
before the detecting of the input keyword,
extracting word appearance data from a search query log containing the input keywords, and creating a language model database by calculating the word appearance probability of the extracted word appearance data.

15. The method of claim 10, wherein the determining of the correct keyword candidate includes:
determining, as the correct keyword candidate, a specific word having the same phonetic index as a pronunciation of the input keyword.

16. The method of claim 10, wherein the determining of the correct keyword candidate includes:
dividing the input keyword into alphabetic letters and then creating bi-gram based on a two-letter combination of the divided letters or tri-gram based on a three-letter combination of the divided letters;
comparing the created bi-gram or tri-gram with n-gram index containing pairs of a word and a corresponding bi-gram or tri-gram; and
determining, as the correct keyword candidate, a specific word corresponding to a matched bi-gram or tri-gram.

17. The method of claim 16, wherein the determining of the correct keyword candidate further includes:
retrieving at least one word containing the bi-gram or tri-gram of the input keyword from the n-gram index;
calculating similarity between the input keyword and each retrieved word; and
determining, as the correct keyword candidate, at least one of the retrieved words in a descending order of the similarity.

18. The method of claim 10, wherein the determining of the correct keyword candidate includes:
comparing the input keyword with words stored in a language model database; and
determining, as the correct keyword candidate, at least one of the stored words in an ascending order of an edit distance from the input keyword, and
wherein the edit distance is the sum of weighted values predefined for each of substitution, addition, deletion and change and also obtained depending on frequency of substitution, addition, deletion or change between alphabetic arrangements of the input keyword and the stored words.
